(19) United States
(12) Patent Application Publication
(10) Pub. No.: US 2014/0186573 A1
(43) Pub. Date: Jul. 3, 2014

(54) Synthetic Laminated Mat

(71) Applicant: The Modern Group, Ltd., Beaumont, TX (US)

(72) Inventor: Orain Tubbs, Beaumont, TX (US)

(73) Assignee: The Modern Group, Ltd., Beaumont, TX (US)

(21) Appl. No.: 14/145,698

(22) Filed: Dec. 31, 2013

Related U.S. Application Data
(60) Provisional application No. 61/748,412, filed on Jan. 2, 2013.
(60) Provisional application No. 61/770,127, filed on Feb. 27, 2013.

(51) Int. Cl. B32B 7/08

(52) U.S. Cl. CPC B32B 7/08
USPC 428/99; 428/105

(57) ABSTRACT

An improved laminated mat which comprises synthetic materials are provided for herein. Embodiments may include a plurality of synthetic boards disposed adjacent to each other to form a top surface. Such a top surface may be configured such that individual boards are replaceable in the event of defects, wear and the like. The top surface may be attached to a lower support layer. This layer may also include a plurality of synthetic boards arranged in a cross-hatched manner with respect to the top surface.

### CROSS-REFERENCE TO RELATED APPLICATIONS

The present application claims priority on U.S. Provisional Application No. 61/748,412, filed Jan. 2, 2013 and entitled “SYNTHETIC LAMINATED MAT,” and U.S. Provisional Application No. 61/770,127 filed Feb. 27, 2013 and entitled “SYNTHETIC LAMINATED MAT,” the disclosures of which are incorporated herein by reference in their entirety.

### TECHNICAL FIELD

The present description relates generally to laminated mats, and more specifically to systems and methods to provide for laminated mats which include synthetic materials.

### BACKGROUND

Laminated mats are in broad use in many industries. These mats tend to have multiple deficiencies which hinder their performance. For example, many are made primarily of wood, such as an untreated wood, which comes in contact with the ground and moisture. Once the mats have been used in the field, the wood is generally moist and at that point they are stacked for storage. However, the moist wood of the mats is generally stacked together in a manner that allows little or no air circulation between the units, which usually causes accelerated rot.

In addition, it is difficult to move stacks of mats, which are generally moved by forklift. Currently, because there is no gap between the mats to insert the forks of a forklift, one would generally be required to manually insert spacers or chocks between each mat when stacking. These mats are used in large quantities on project sites, and it is not cost effective to have a person manually placing spacers between several thousand mats when stacking for storage.

Another type of mat used in an oilfield is called a laminated mat. These mats are generally constructed out of 2 inch by 8 inch boards to make a 6 inch by 8 foot by 12 or 14 foot section. These mats are also constructed almost entirely of wood and have the same drawbacks associated with the other design.

In addition, because current mats are constructed of wood which is fastened together, one cannot easily repair or replace the individual sections of the mats in the field. Wear from continued use and/or damage from heavy equipment used in the field can cause individual pieces of wood used to construct the mats to disintegrate and fall from the constructed mats. This disintegration causes loss of compression and torque of the bolts and nails holding the unit together. It also makes the mat no longer useable.

Another type of mat may be referred to as a synthetic mat. A synthetic mat generally comprises a large piece of rubber (e.g. 7 foot×13 foot) which is configured to be bolted together with another mat. These mats are generally made in one large piece during an injection molding process where the synthetic material is injected into a compression mold to form the mat.

While these mats generally do not have the same rotting problems as wood mats, synthetic mats are not in wide use due to various disadvantages. For example, in the event that there is rain at the location of the mat, water tends to stay on top of the mat thereby causing slippery conditions. Synthetic mats tend to be more labor intensive to deploy as they generally require hand labor to bolt together. Moreover, synthetic mats generally have a hollow core. Because of this, if the mat is ever pierced, water fills into the core and causes the mat to be much heavier which creates difficulties in transporting and deploying the mats. Further, if the mats are utilized in a cold environment, water expansion when freezing further damages the mats. Another disadvantage of synthetic mats is that because they generally comprise one large piece of surface material, they generally are not repairable in a cost-effective manner in the event that the mat is damaged.

### BRIEF SUMMARY

Systems, apparatuses and methods which provide for an improved laminated mat which comprises synthetic materials are provided for herein. Such mats may include a plurality of inventive features. For example, some embodiments provide for replaceable top surfaces which allow for portions of the mat to be replaced if in need of repairs, e.g. after excessive wear and tear, and the like. Such top surfaces may include a plurality of boards or slats made from a synthetic material which are attached to a lower support layer. The boards may be attached in a manner which allows for simple replacement of a defective board (e.g. using a plurality of carriage bolts and utilizing little or no nails). Further, the boards may be attached in a manner so as to allow water to drain between the boards.

In one aspect, a synthetic laminated mat may comprise a plurality of layers. For example a synthetic laminated mat may include a top layer of individual boards which is connected to a lower layer of individual boards where the layers are cross-hatched with respect to each other to provide for strength and stability. In one further aspect, a middle layer of supports may be placed between one or more layers of a mat in order to provide for more stability and to prevent the mat from racking. Additional layers may be likewise added as desired in order to provide for additional strength of the mat in circumstances which may require such.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1A illustrates a top view of a synthetic laminated mat in accordance with an embodiment of the present application;

FIGS. 1B and 1D illustrate a bottom view of a synthetic laminated mat in accordance with an embodiment of the present application;

FIG. 1C illustrates a perspective view of a synthetic laminated mat in accordance with an embodiment of the present application;

FIG. 2A illustrates a top view of a synthetic laminated mat in accordance with an embodiment of the present application;

FIG. 2B illustrates a bottom view of a synthetic laminated mat in accordance with an embodiment of the present application;

FIG. 2C illustrates a perspective view of a synthetic laminated mat in accordance with an embodiment of the present application;

FIG. 3A illustrates an enlarged plan view of a synthetic laminated mat in accordance with an embodiment of the present application;

FIG. 3B illustrates a side cut-away view of a synthetic laminated mat in accordance with an embodiment of the present application;

FIGS. 4A and 4B illustrate a top view of a synthetic laminated mat and an attachment means in accordance with an embodiment of the present application; and

FIG. 5 illustrates a method flow for forming a synthetic laminated mat in accordance with an embodiment of the present application.

### DESCRIPTION

It is noted that the following discussion of the figures will be in the context of the embodiments illustrated in the provided drawings. To the extent that the provided drawings note specific measurements, layers, attachment locations for materials, and the like, these specific values are given by way of example and are not intended to be limiting. It is contemplated that mats having different size boards, additional layers to accommodate for increased loads, different attachment means or locations, and the like, may be made in accordance with the described inventive concepts.

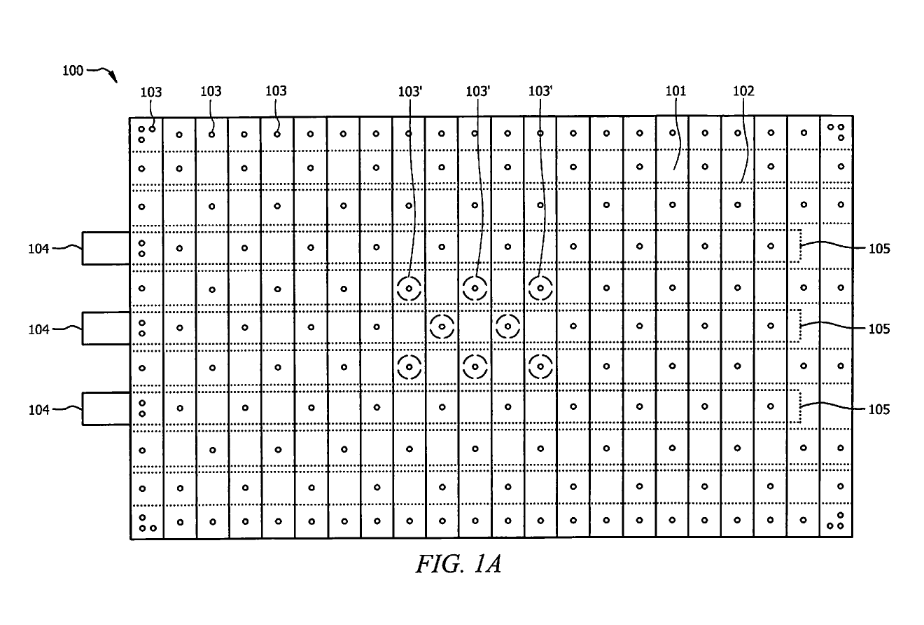

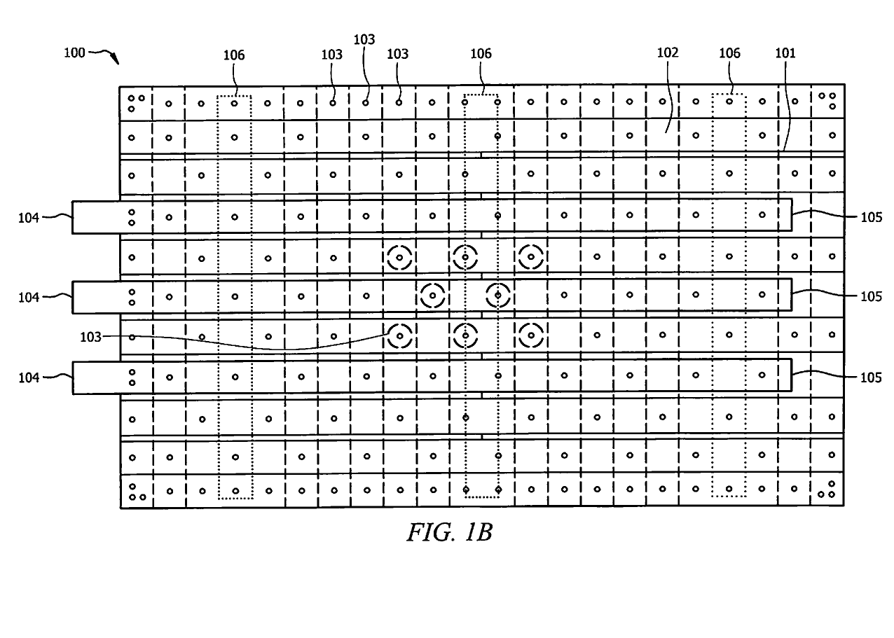

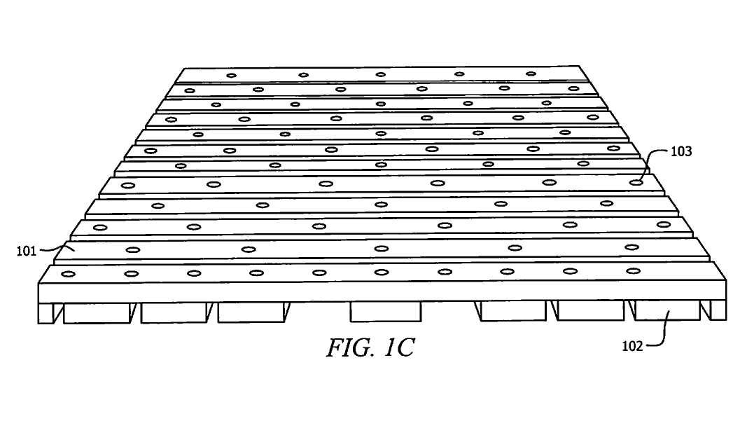

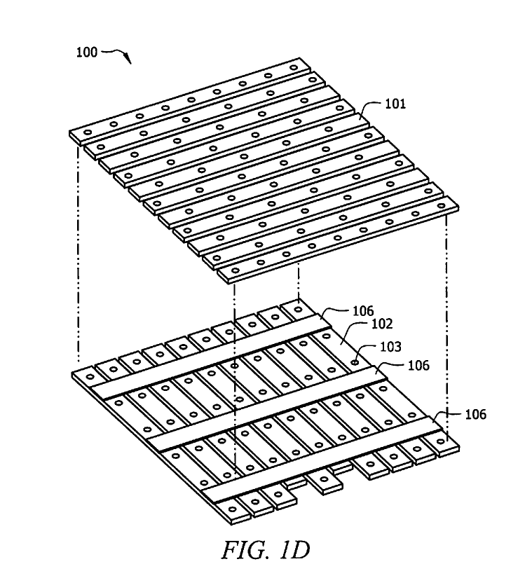

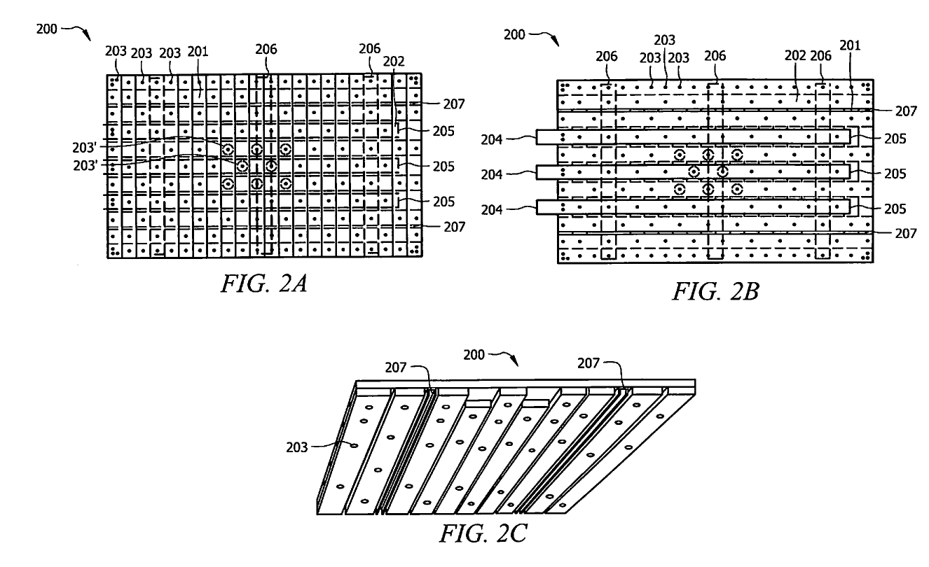

FIG. 1A illustrates a top view of a synthetic laminated mat 100 in accordance with an embodiment of the present application. FIGS. 1B and 1D illustrate a bottom view and FIG. 1C illustrates a perspective view respectively of synthetic laminated mat 100. FIGS. 2A-2C illustrate another embodiment of a synthetic laminated mat 200 from a top, bottom and perspective view respectively. Referring to FIGS. 1 and 2, synthetic laminated mat 100 and 200 are shown which includes at least two layers of synthetic boards, e.g. a top layer 101/201 and a bottom layer 102/202 (shown by dashed lines), which are disposed in a cross-hatched layout. The layers are bolted together in a manner to provide for stability and prevent deformation of the mat.

It is noted that in some embodiments a third (or more) layer may be added to provide for higher load capacity. Such an additional layer may be added in a cross-hatched manner with respect to the most adjacent layer. It is further noted that the ability to add a layer provides for advantages over previously fabricated synthetic laminated mats which have large continuously molded surfaces. For example, in the event that a user of a mat needs an additional 30% capacity, there is no manner to add to the completed molded material. Rather, a new mat would be required.

In the illustrated embodiments of FIGS. 1 and 2, the synthetic boards are made to be 1.5 inches thick and 7.5 inches wide and are disposed adjacently in a slatted formation. It is noted that various sizes may be utilized, however, the illustrated embodiment would more readily interlock with existing wood mats. Therefore, users who are interchanging old wood mats for new synthetic laminated mats may make the exchange as replacement of existing materials is needed. It is noted that embodiments may be otherwise customized to be utilized with other types of materials in a similar manner.

Embodiments may also vary in spacing between boards in accordance with desired usage. For example, a wider spacing may allow for improved water runoff. However, more narrow spacing (e.g. directly adjacent) reduces trip hazards in the field and strengthens the mat. In some embodiments, synthetic boards on the top surface may be substantially closed (e.g. having minimal spacing). Such a design would not be practical for previously implemented wood mats as it would increase rotting problems.

In some embodiment, one or more of the boards on the surface layer of the synthetic laminated mat may be fastened using only bolts, such as bolts 103/203. With previous mats, bolts and nails are generally needed to prevent racking. However, as time wears on, the nails become loose and can be a hazard for vehicles on the mats and a safety hazard for persons walking on the mats. Further, when repairing boards in a mat, the additional removal of nails becomes cumbersome. Accordingly, the ability to use bolts reduces the number of tools needed at the site, increases the speed of repairs, etc. As seen in the illustrated embodiment, bolts 103/203 may also disposed in a triangle pattern and additional bolts are utilized around the edges and corners than are utilized in the center of mat 100/200. One or more of these patterns may be utilized to increase the fastening strength and to help maintain the shape of the mat, e.g. to prevent racking.

The synthetic laminated mat 100/200 of FIGS. 1 and 2 also includes a finger-locking system where one or more boards may extend beyond the outer edge (at 104) or terminate short of the edge (at 105) of mat 100/200. Such a system allows for multiple mats to be interlocked together as opposed to previously constructed synthetic laminated mats which generally require a field worker to bolt or otherwise attach adjacent mats.

In some embodiments, a synthetic laminated mat may also include one or more metal strips 106/206 (shown in FIGS. 1-2). These strips may be added as a middle layer between an upper and lower synthetic board layer to provide for additional strength in the mat. Alternatively, these strips may be added as part of a bottom layer between synthetic boards.

In the illustrated embodiments of synthetic laminated mats 100/200, metal strips 106/206 are cross-hatched with respect to top layer 101/201, but are parallel with bottom layer 102/202. While this particular layout is not required, it is noted that bolting the top layer to a cross-hatched layer assists in maintaining the squareness of the mat. It is further noted that not all of the bolts of the illustrated embodiment are necessarily disposed through the metal strips.

In one embodiment, synthetic laminated mat 200 may also utilize one or more metal channels 207 which are disposed along the length of synthetic laminated mat 200. The use of these metal channels 207 may be implemented in various circumstances to increase the strength of mat 200, prevent racking, etc. In some embodiments, multiple channels 207 may be utilized to increase the strength of mat 200, e.g., in place of adding an additional layer of synthetic boards to the mat. The use of metal is helpful for strength, structural stability, and size minimization, however, in some instances the metal materials may come at higher cost. It is appreciated that this tradeoff will be specific to a user's preferences and embodiments may be customized accordingly.

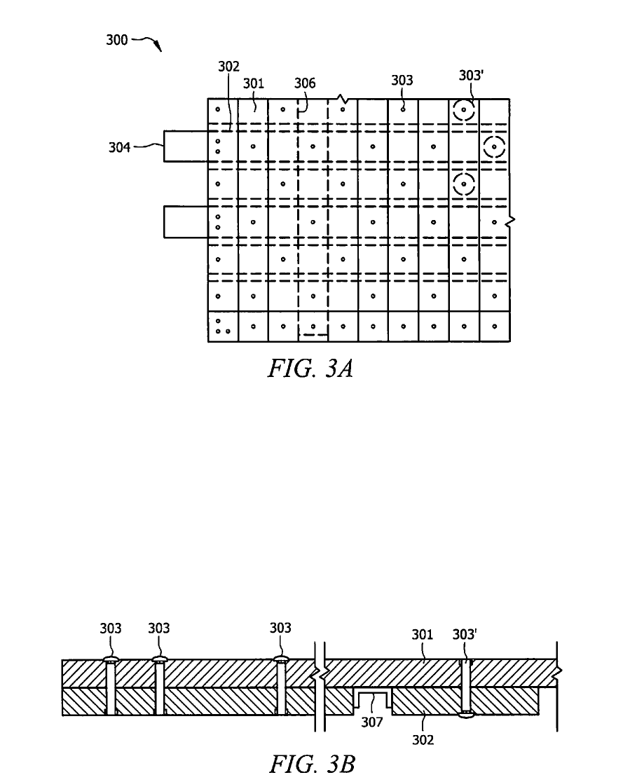

Referring to the section detail diagram of FIG. 3, embodiments may utilize carriage bolts which are countersunk with a nut in a manner that a smooth top surface is provided. Further, bolts may be sunk through one or more of the previously discussed metal strips or channels.

FIG. 3A illustrates an enlarged plan view of a synthetic laminated mat 300 in accordance with an embodiment of the present application. Synthetic mat 300 includes a top surface 301, bottom surface 302, connectors 303, and extension portions 304. FIG. 3B illustrates a side cut-away view of synthetic laminated mat 300. In some embodiments, bolts are used as connectors 303 and are configured to attach one or more layers of materials in a manner where a portion of the bolts 303′ are reversed in direction, e.g. where the head of the bolt is facing down (i.e. proximate to the bottom surface of mat 300). Such bolts are also illustrated by the circled bolts 103′ and 203′ of FIGS. 1 and 2. Embodiments may dispose one or more bolts in this manner to help electrically ground the mat to prevent buildup of static electricity. Further, in some embodiments, copper head bolts may be utilized for each of bolts 303/303′, or for one or more of bolts 303′ to assist with electrical grounding.

It is noted that embodiments may utilize various forms of synthetic materials and metals to accomplish the above-described structures. Each material may have different properties to provide for preferences for strength, stability, surface grip, and the like. It is further noted that while the above embodiments utilized bolts for attaching portions of a synthetic laminated mat together, other fasteners may be utilized such as rivets, and the like.

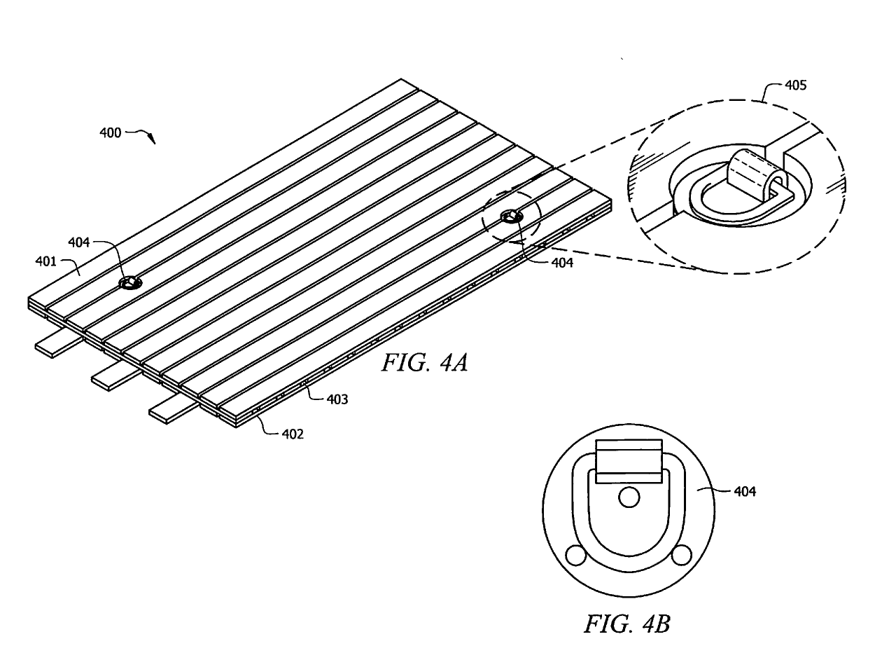

FIG. 4 illustrates a top view of a synthetic laminated mat 400 in accordance with an embodiment of the present application. Synthetic laminated mat 400 includes a top layer 401, bottom layer 402, and middle layer 403. Such layers are disposed in a cross-hatched manner.

Synthetic laminated mat 400 further includes an attachment means 404. In some applications, it is useful to include an attachment means 404 on a mat 400 for various reasons, e.g. to assist in lifting/placing the mat, to secure something to the mat, etc. Traditionally, wood laminated mats have only utilized cable loops to accomplish such an attachment means because wood rot causes other types of attachment methods to pull out or detach from the mat. Such issues are overcome with the present synthetic laminated mat embodiments. In one embodiment attachment means 404 is implemented with one or more D-Rings (see FIGS. 4A-4B). A D-ring may be configured to be recessed into the mat (as shown in exploded view 405) to be out of the way of foot and vehicle traffic. In this manner, the attachment means 404 reduces trip hazards and prevents damage caused by the attachment means 404 on other mates when a plurality of mats are stacked for storage (which tends to be a problem with cable loops). The illustrated D-ring attachment means may be bolted into the second layer of the synthetic mat to provide for additional stability for lift support.

Embodiments may include a plurality of attachment means 404, such as D-Rings 404 disposed about the synthetic mat 400 in a manner which allows the synthetic laminated mat to be lifted or otherwise moved from various points of connection. In one embodiment, two attachment means 404 may be provided on opposing sides of mat 400 in a manner which allows a lifting device to connect to attachment means 404 and lift mat 400 and maintain mat 400 in a substantially level orientation to prevent sudden tipping or dropping of mat 400. In another embodiment, additional attachment means 404 may be provided at other points to provide further stability (e.g. in the four corners, in the center, and the like).

It is noted that other forms of attachment means may be utilized such as cable loops or other forms of latches or rings. Such means may be secured in a recessed manner or on top of the synthetic laminated mat. Each method will have various advantages and disadvantages which are apparent to one of skill in the art. However, it is appreciated that due to the construction of the overall synthetic mat, such attachment means may be better secured to the mat for longer term use and reduced failures than has been previously been available with mat devices.

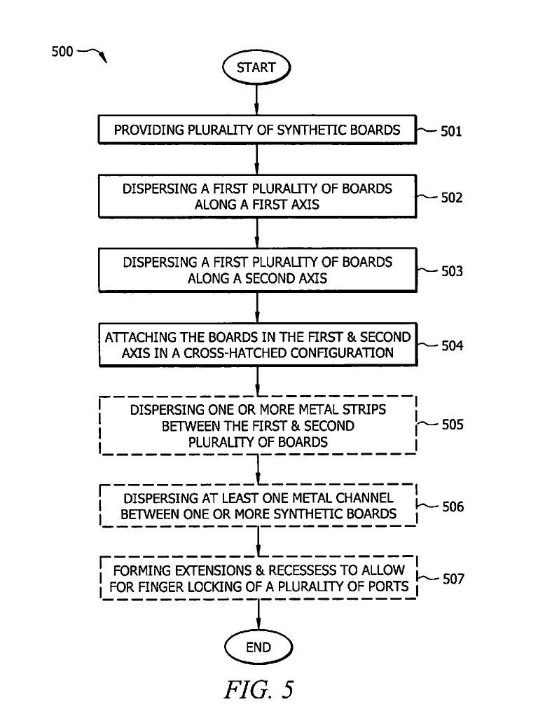

It is noted that embodiments may also comprise methods for creating and/or using a synthetic laminated mat as shown in FIG. 5. For example, a method 500 for creating a synthetic laminated mat may comprise one or more steps of creating or providing a plurality of synthetic boards 501. A first plurality of synthetic boards are disposed along a first axis 502, and a second plurality of boards are disposed along a second axis 503. Method 500 may further include attaching the first plurality of synthetic boards and second plurality of synthetic boards in a cross-hatched manner 504. In accordance with more detailed embodiments, the method 500 may comprise disposing one or more metal strips between the upper and lower layers of synthetic boards and attaching them thereto 505. Further method 500 may include disposing metal channels between one or more synthetic boards to provide for added stability 506. The method 500 may also include forming extensions and recesses in the synthetic laminated mat in a manner which allows for finger locking between one or more mats 507.

In a further embodiment, the method may also include for adding additional layers of synthetic boards which may provide for additional strengthening of the mat. A method of use may comprise providing a plurality of synthetic laminated mats having an upper surface which includes a plurality of synthetic boards which are attached to a lower surface and disposing the plurality of mats adjacent to each other to form a path for vehicles to travel thereon. In accordance with more detailed embodiments, the method may comprise disposing a synthetic laminated mat to be adjacent to one or more wood mats.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the claims which issue from this application are intended to include within their scope such processes, machines, manufacture, compositions of matter, means, methods, or steps.

What is claimed is:

1. A synthetic laminated mat comprising:
a top layer having a plurality of synthetic boards disposed side by side;
a lower layer having a plurality of synthetic boards disposed in a cross-hatched manner with respect to the top layer, wherein the top layer and lower layer are attached with a plurality of fasteners in a manner configured to maintain the shape and structure of the mat.

2. The synthetic laminated mat of claim 1 further comprising at least one intermediate layer configured to provide additional load strength to the mat.

3. The synthetic laminated mat of claim 2 wherein the at least one intermediate layer comprises a plurality of metal strips disposed in a cross-hatched manner with respect to the top layer.

4. The synthetic laminated mat of claim 2 wherein the at least one intermediate layer comprises a layer of synthetic boards disposed in a cross-hatched manner with respect to the top layer.

5. The synthetic laminated mat of claim 2 or 3 wherein the at least one intermediate layer further comprises a metallic channel.

6. The synthetic laminated mat of claim 1 wherein the fasteners comprise plurality of bolts.

7. The synthetic laminated mat of claim 6 wherein at least one of the plurality of bolts are fastened in a manner to assist in providing for electrical grounding the mat.

8. The synthetic laminated mat of claim 1 wherein one or more of the layers are configured to finger lock with a second mat.

9. The synthetic laminated mat of claim 1 wherein the plurality of synthetic boards are disposed in a manner where they are directly adjacent to each other.

10. The synthetic laminated mat of claim 1 further comprising at least one attachment means disposed on the top surface of the mat.

11. The synthetic laminated mat of claim 10 wherein the at least one attachment means is recessed into the top layer of the mat.

12. The synthetic laminated mat of claim 11 wherein the at least one attachment means is attached to a lower layer of the mat.

13. The synthetic laminated mat of claim 10 wherein the attachment means comprises at least one D-Ring.

14. The synthetic laminated mat of claim 1 further comprising a plurality of D-Rings disposed on a top layer of the mat on opposing sides.
